(19) United States
(12) Patent Application Publication
(10) Pub. No.: US 2026/0095910 A1
(43) Pub. Date: Apr. 2, 2026

(54) METHOD AND APPARATUS FOR FREQUENCY DOMAIN RESOURCE INDICATION IN MULTI-CELL SCHEDULING SCENARIO

(71) Applicant: LENOVO (BEIJING) LIMITED, Beijing (CN)

(72) Inventor: Haipeng Lei, Beijing (CN)

(21) Appl. No.: 19/113,063

(22) PCT Filed: Feb. 10, 2023
(86) PCT No.: PCT/CN2023/075384

§ 371 Date: Mar. 19, 2025

(51) Int. Cl. H04W 72/1268; H04W 72/232

(52) U.S. Cl. CPC H04W 72/1268; H04W 72/232

(57) ABSTRACT

Embodiments of the present disclosure relate to methods and apparatuses for frequency domain resource indication in a multi-cell scheduling scenario. According to some embodiments of the disclosure, a UE may: receive, from a BS, a DCI format scheduling a first set of cells among a second set of cells configured for the UE by the BS, wherein the DCI format includes a first field indicating whether one or multiple cells are scheduled by the DCI format and a second field for indicating frequency domain resource assignment; determine RBs assigned on the first set of cells based on the first and second fields; and receive, from the BS, downlink transmissions on the assigned RBs in the case that the DCI format schedules the downlink transmissions, or transmit, to the BS, uplink transmissions on the assigned RBs in the case that the DCI format schedules the uplink transmissions.

### TECHNICAL FIELD

Embodiments of the present disclosure generally relate to wireless communication technology, and more particularly to frequency domain resource indication in a multi-cell scheduling scenario.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a base station (BS) and a user equipment (UE) may communicate via downlink (DL) channels and uplink (UL) channels. For example, a UE may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH).

Carrier aggregation (CA) technology may be used in a wireless communication system to, for example, increase data rates. For example, CA technology may refer to aggregating spectrum resources (e.g., carriers or cells) from the same frequency band or different frequency bands. In a CA scenario, multiple cells may be configured for a UE and DL or UL channels may be carried on one or more of the multiple cells.

There is a need for handling frequency domain resource assignment for uplink and downlink transmissions scheduled by a DCI in a CA scenario.

### SUMMARY

Some embodiments of the present disclosure provide a user equipment (UE). The UE may include a transceiver, and a processor coupled to the transceiver. The processor may be configured to: receive, from a BS, a DCI format scheduling a first set of cells among a second set of cells configured for the UE by the BS, wherein the DCI format includes a first field indicating whether one or multiple cells are scheduled by the DCI format and a second field for indicating frequency domain resource assignment; determine resource blocks (RBs) assigned on the first set of cells based on the first and second fields; and receive, from the BS, downlink transmissions on the assigned RBs in the case that the DCI format schedules the downlink transmissions, or transmit, to the BS, uplink transmissions on the assigned RBs in the case that the DCI format schedules the uplink transmissions.

In some embodiments of the present disclosure, a size of the first field is equal to one bit. In some embodiments of the present disclosure, the first field indicates the first set of cells, and the size of the first field is dependent on a number of cells in the second set of cells.

In some embodiments of the present disclosure, the second field indicates a set of interlaces on a bandwidth of a virtual cell formed by aggregating all cells of the second set of cells according to a predefined order.

In some embodiments of the present disclosure, a size of the second field is dependent on a total number of interlaces on the bandwidth of the virtual cell.

In some embodiments of the present disclosure, the second field includes a plurality of RB group (RBG) based indicators, each of which corresponds to a cell of the second set of cells and indicates assigned RBGs on a corresponding cell.

In some embodiments of the present disclosure, a size of each RBG-based indicator of the plurality of RBG-based indicators is dependent on a resource allocation type for a corresponding cell, an RBG granularity for the corresponding cell, and one of the following: associated carrier bandwidth of the corresponding cell, the largest bandwidth among bandwidth parts (BWPs) of the corresponding cell, and a bandwidth of the current active BWP of the corresponding cell.

In some embodiments of the present disclosure, the plurality of RBG-based indicators in the second field are arranged according to a predefined order.

In some embodiments of the present disclosure, a number of the downlink transmissions or uplink transmissions is equal to a number of cells in the first set of cells.

Some embodiments of the present disclosure provide a user equipment (UE). The UE may include a transceiver, and a processor coupled to the transceiver. The processor may be configured to: receive, from a BS, a DCI format scheduling a first set of cells among a second set of cells configured for the UE by a BS, wherein the DCI format includes at least one frequency domain resource assignment (FDRA) field; determine the first set of cells based on the at least one FDRA field; determine RBs assigned on the first set of cells based on the at least one FDRA field; and receive, from the BS, downlink transmissions on the assigned RBs in the case that the DCI format schedules the downlink transmissions, or transmit, to the BS, uplink transmissions on the assigned RBs in the case that the DCI format schedules the uplink transmissions.

In some embodiments of the present disclosure, each of the at least one FDRA field corresponds to a cell of the second set of cells and indicates assigned RBs on a corresponding cell.

In some embodiments of the present disclosure, a size of each FDRA field of the at least one FDRA field is dependent on a resource allocation type for a corresponding cell, an RBG granularity for the corresponding cell, and one of the following: associated carrier bandwidth of the corresponding cell, the largest bandwidth among bandwidth parts (BWPs) of the corresponding cell, or a bandwidth of the current active BWP of the corresponding cell.

In some embodiments of the present disclosure, an RBG granularity for each cell of the second set of cells is independently configured by the BS. In some embodiments of the present disclosure, a resource allocation type for each cell of the second set of cells is independently configured by the BS. In some embodiments of the present disclosure, RBG granularities for different resource allocation types for each cell of the second set of cells are independently configured by the BS.

In some embodiments of the present disclosure, the configured RBG granularity for a cell of the second set of cells is dependent on one of the following: associated carrier bandwidth of the cell, the largest bandwidth among the bandwidth part (BWPs) of the cell, or a bandwidth of the current active BWP of the cell.

In some embodiments of the present disclosure, all cells of the second set of cells have the same resource allocation type. In some embodiments of the present disclosure, all cells of the second set of cells have the same RBG granularity, which is dependent on a total bandwidth of the second set of cells.

In some embodiments of the present disclosure, the at least one FDRA field includes a single FDRA field, which indicates assigned RB groups (RBGs) on a virtual cell formed by aggregating all cells of the second set of cells according to a predefined order.

In some embodiments of the present disclosure, a size of the single FDRA field is dependent on a total bandwidth of the second set of cells and an RBG granularity for the second set of cells.

In some embodiments of the present disclosure, a number of the downlink transmissions or uplink transmissions is equal to a number of cells in the first set of cells.

Some embodiments of the present disclosure provide a BS. The BS may include a transceiver, and a processor coupled to the transceiver. The processor may be configured to: configure a second set of cells for a UE; transmit, to the UE, a DCI format for scheduling RBs on a first set of cells among the second set of cells, wherein the DCI format includes a first field indicating whether one or multiple cells are scheduled by the DCI format and a second field for indicating frequency domain resource assignment, and the scheduled RBs are indicated by the first and second fields; and transmit, to the UE, downlink transmissions on the scheduled RBs in the case that the DCI format schedules the downlink transmissions, or receive, from the UE, uplink transmissions on the scheduled RBs in the case that the DCI format schedules the uplink transmissions.

In some embodiments of the present disclosure, a size of the first field is equal to one bit. In some embodiments of the present disclosure, the first field indicates the first set of cells, and the size of the first field is dependent on a number of cells in the second set of cells.

In some embodiments of the present disclosure, the second field indicates a set of interlaces on a bandwidth of a virtual cell formed by aggregating all cells of the second set of cells according to a predefined order.

In some embodiments of the present disclosure, the scheduled RBs are RBs within the intersection of the first set of cells and the set of interlaces.

In some embodiments of the present disclosure, the interlace is an RB-based interlace, and a total number of RB-based interlaces on the bandwidth of the virtual cell is: dependent on the SCS of the second set of cells; configured by the BS; or dependent on a number of RBs between two consecutive RBs of a single interlace on the bandwidth of the virtual cell.

In some embodiments of the present disclosure, the interlace is an RBG based interlace, and a total number of RBG-based interlaces on the bandwidth of the virtual cell and an RBG size associated with the RBG-based interlace are configured by the BS.

In some embodiments of the present disclosure, a size of the second field is dependent on a total number of interlaces on the bandwidth of the virtual cell.

In some embodiments of the present disclosure, the second field includes a plurality of RBG based indicators, each of which corresponds to a cell of the second set of cells and indicates scheduled RBGs on a corresponding cell.

In some embodiments of the present disclosure, a size of each RBG-based indicator of the plurality of RBG-based indicators is dependent on a resource allocation type for a corresponding cell, an RBG granularity for the corresponding cell, and one of the following: associated carrier bandwidth of the corresponding cell, the largest bandwidth among BWPs of the corresponding cell, and a bandwidth of the current active BWP of the corresponding cell.

In some embodiments of the present disclosure, the processor is further configured to determine an RBG granularity associated with an RBG-based indicator corresponding to each cell of the first set of cells according to a number of cells in the first set of cells.

In some embodiments of the present disclosure, in the case that the number of cells in the first set of cells is greater than a threshold, the RBG granularity associated with an RBG-based indicator corresponding to each cell of the first set of cells is an RBG granularity for a corresponding cell of the first set of cells. In some embodiments of the present disclosure, in the case that the number of cells in the first set of cells is smaller than or equal to the threshold, the RBG granularity associated with an RBG-based indicator corresponding to each cell of the first set of cells is smaller than or equal to an RBG granularity for a corresponding cell of the first set of cells.

In some embodiments of the present disclosure, the plurality of RBG-based indicators in the second field are arranged according to a predefined order.

In some embodiments of the present disclosure, a number of the downlink transmissions or uplink transmissions is equal to a number of cells in the first set of cells.

Some embodiments of the present disclosure provide a BS. The BS may include a transceiver, and a processor coupled to the transceiver. The processor may be configured to: configure a second set of cells for a UE; transmit, to the UE, a DCI format for scheduling RBs on a first set of cells among the second set of cells, wherein the DCI format includes at least one FDRA field, and the first set of cells and the scheduled RBs are indicated by the at least one FDRA field; and transmit, to the UE, downlink transmissions on the scheduled RBs in the case that the DCI format schedules the downlink transmissions, or receive, from the UE, uplink transmissions on the scheduled RBs in the case that the DCI format schedules the uplink transmissions.

In some embodiments of the present disclosure, each of the at least one FDRA field corresponds to a cell of the second set of cells and indicates scheduled RBs on a corresponding cell.

In some embodiments of the present disclosure, a size of each FDRA field of the at least one FDRA field is dependent on a resource allocation type for a corresponding cell, an RBG granularity for the corresponding cell, and one of the following: associated carrier bandwidth of the corresponding cell, the largest bandwidth among BWPs of the corresponding cell, or a bandwidth of the current active BWP of the corresponding cell.

In some embodiments of the present disclosure, the processor is further configured to, for each cell of the second set of cells: in the case that a corresponding cell is not scheduled by the DCI format, set a corresponding FDRA field of the at least one FDRA field to indicate an inapplicable value; or in the case that the corresponding cell is scheduled by the DCI format, set the corresponding FDRA field of the at least one FDRA field to indicate an applicable value.

In some embodiments of the present disclosure, the processor is further configured to perform at least one of the following: independently configuring an RBG granularity for each cell of the second set of cells; independently configuring a resource allocation type for each cell of the second set of cells; or independently configuring RBG granularities for different resource allocation types for each cell of the second set of cells.

In some embodiments of the present disclosure, the configured RBG granularity for a cell of the second set of cells is dependent on one of the following: associated carrier bandwidth of the cell, the largest bandwidth among BWPs of the cell, or a bandwidth of the current active BWP of the cell.

In some embodiments of the present disclosure, all cell of the second set of cells have the same resource allocation type. In some embodiments of the present disclosure, all cells of the second set of cells have the same RBG granularity, which is dependent on a total bandwidth of the second set of cells.

In some embodiments of the present disclosure, the at least one FDRA field includes a single FDRA field, which indicates scheduled RBGs on a virtual cell formed by aggregating all cells of the second set of cells according to a predefined order.

In some embodiments of the present disclosure, a size of the single FDRA field is dependent on a total bandwidth of the second set of cells and an RBG granularity for the second set of cells.

In some embodiments of the present disclosure, the processor is further configured to: for each cell of the second set of cells, in the case that a corresponding cell is not scheduled by the DCI format, set the single FDRA field to indicate no complete or partial RBG on the corresponding cell; or in the case that the corresponding cell is scheduled by the DCI format, set the single FDRA field to indicate at least one complete RBG or at least one partial RBG on the corresponding cell.

In some embodiments of the present disclosure, a number of the downlink transmissions or uplink transmissions is equal to a number of cells in the first set of cells.

Some embodiments of the present disclosure provide a method performed by a UE. The method may include: receiving, from a BS, a DCI format scheduling a first set of cells among a second set of cells configured for the UE by the BS, wherein the DCI format includes a first field indicating whether one or multiple cells are scheduled by the DCI format and a second field for indicating frequency domain resource assignment; determining RBs assigned on the first set of cells based on the first and second fields; and receiving, from the BS, downlink transmissions on the assigned RBs in the case that the DCI format schedules the downlink transmissions, or transmitting, to the BS, uplink transmissions on the assigned RBs in the case that the DCI format schedules the uplink transmissions.

Some embodiments of the present disclosure provide a method performed by a UE. The method may include: receiving, from a BS, a DCI format scheduling a first set of cells among a second set of cells configured for the UE by a BS, wherein the DCI format includes at least one FDRA field; determining the first set of cells based on the at least one FDRA field; determining RBs assigned on the first set of cells based on the at least one FDRA field; and receiving, from the BS, downlink transmissions on the assigned RBs in the case that the DCI format schedules the downlink transmissions, or transmitting, to the BS, uplink transmissions on the assigned RBs in the case that the DCI format schedules the uplink transmissions.

Some embodiments of the present disclosure provide a method performed by a BS. The method may include: configuring a second set of cells for a UE; transmitting, to the UE, a DCI format for scheduling RBs on a first set of cells among the second set of cells, wherein the DCI format includes a first field indicating whether one or multiple cells are scheduled by the DCI format and a second field for indicating frequency domain resource assignment, and the scheduled RBs are indicated by the first and second fields; and transmitting, to the UE, downlink transmissions on the scheduled RBs in the case that the DCI format schedules the downlink transmissions, or receiving, from the UE, uplink transmissions on the scheduled RBs in the case that the DCI format schedules the uplink transmissions.

Some embodiments of the present disclosure provide a method performed by a BS. The method may include: configuring a second set of cells for a UE; transmitting, to the UE, a DCI format for scheduling RBs on a first set of cells among the second set of cells, wherein the DCI format includes at least one FDRA field, and the first set of cells and the scheduled RBs are indicated by the at least one FDRA field; and transmitting, to the UE, downlink transmissions on the scheduled RBs in the case that the DCI format schedules the downlink transmissions, or receiving, from the UE, uplink transmissions on the scheduled RBs in the case that the DCI format schedules the uplink transmissions.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate schematic diagrams of a DCI format scheduling a plurality of transmissions in accordance with some embodiments of the present disclosure;

FIG. 4 illustrates an exemplary virtual cell in accordance with some embodiments of the present disclosure;

FIG. 5 illustrates an example of RB-based interlace structure in accordance with some embodiments of the present disclosure;

FIG. 6 illustrates an example of RBG-based interlace structure in accordance with some embodiments of the present disclosure;

FIGS. 7-10 illustrate flow charts of an exemplary procedure of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

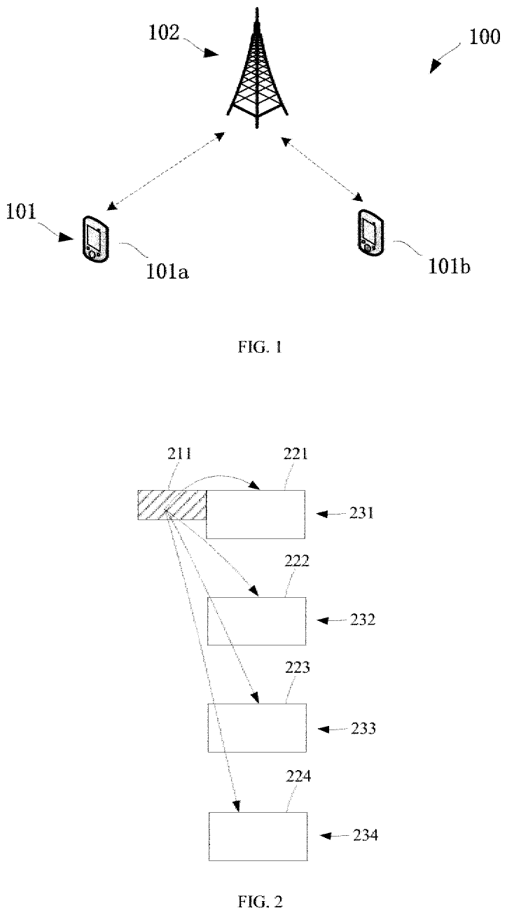

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A communication technology (e.g., NR) may support a wide range of spectrums in different frequency ranges. For example, in the 5G Advanced market, it is expected that the availability of the spectrum will be increased, which is possibly due to re-farming the bands originally used for previous cellular generation networks. For example, for some low frequency bands of frequency range 1 (FR1) (e.g., 410 MHz-7125 MHZ), the available spectrum bands tend to be more fragmented and scattered with a narrower bandwidth. In addition, for bands of frequency range 2 (FR2) (e.g., 24250 MHz-52600 MHz) and some bands of FR1, the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth become available, it is advisable to allow simultaneous scheduling of multiple cells.

A communication system (e.g., NR) may be designed to support a maximum of 16 component carriers (CCs) in the case of carrier aggregation (CA) or a maximum of 32 CCs in the case of dual connectivity (DC). In some embodiments of the present application, in the case of CA, one DCI format can schedule at most one cell (e.g., carrier) by cross-cell (or cross-carrier) scheduling or self-scheduling. This requires much signaling overhead for PDCCHs to schedule DL transmissions (e.g., PDSCHs) or UL transmissions (e.g., PUSCHs) when the number of cells configured for a UE is large. To reduce signaling overhead, it would be beneficial to use a single DCI format to schedule multiple PDSCHs or PUSCHs on multiple cells configured for the UE, which is referred to as multi-cell scheduling in the context of the present disclosure. Meanwhile, a tradeoff between signaling overhead reduction and scheduling restriction has to be taken into account.

FIG. 2 illustrates a schematic diagram of a DCI format scheduling a plurality of transmissions in accordance with some embodiments of the present disclosure.

In some embodiments of the present disclosure, a plurality of CCs (e.g., including but not limited to CCs 231-234 in FIG. 2) may be configured for a UE. It should be understood that the sub-carrier spacings (SCSs) of the cells configured for a UE may be the same or different. Each of the plurality of CCs may correspond to a respective cell (e.g., serving cell) or carrier of the UE. Each cell (serving cell) may be associated with a (serving) cell index.

In some embodiments of the present disclosure, instead of using separate DCI formats to respectively schedule a plurality of transmissions on a plurality of cells, a BS may transmit a single DCI format to schedule the plurality of transmissions on the plurality of cells. For example, as shown in FIG. 2, DCI format 211 may schedule transmissions 221-224 on CCs 231-234, where each CC carries a single transmission.

In some examples, transmissions 221-224 may be uplink transmissions, for example, uplink physical data channels such as PUSCHs. In some examples, transmissions 221-224 may be downlink transmissions, for example, downlink physical data channels such as PDSCHs.

In FIG. 2, the cell (i.e., CC 231) on which DCI format 211 is detected carries one (e.g., transmission 221) of the scheduled transmissions. This may be referred to as self-scheduling. Other transmissions (e.g., transmissions 222-224) of the scheduled transmissions are scheduled on cells different from the one (i.e., CC 231) on which DCI format 211 is detected. This may be referred to as cross-cell (or cross-carrier) scheduling.

Although in FIG. 2, DCI format 211 schedules a plurality of transmissions via both self-scheduling and cross-cell scheduling, it should be understood that a DCI format may schedule a plurality of transmissions via only cross-cell scheduling. FIG. 3 shows such an example. It also should be understood that a cell (e.g., a CC) scheduled by a DCI format may carry more than one transmission (e.g., PDSCHs or PUSCHs) in some other embodiments of the present disclosure.

FIG. 3 illustrates a schematic diagram of a DCI format scheduling a plurality of transmissions in accordance with some embodiments of the present disclosure.

In some embodiments of the present disclosure, a plurality of CCs (e.g., including but not limited to CCs 331-335 in FIG. 3) may be configured for a UE. It should be understood that the sub-carrier spacings (SCSs) of the cells configured for a UE may be the same or different. Each of the plurality of CCs may correspond to a respective cell (e.g., serving cell) or carrier of the UE. Each cell (serving cell) may be associated with a (serving) cell index.

As shown in FIG. 3, DCI format 311 may be transmitted on CC 331, and schedule transmissions 321-324 on CCs 332-335, where each CC carries a single transmission. In some examples, transmissions 321-324 may be uplink transmissions, for example, uplink physical data channels such as PUSCHs. In some examples, transmissions 321-324 may be downlink transmissions, for example, downlink physical data channels such as PDSCHs.

When a DCI format schedules a single transmission on a single cell, the DCI format may indicate the frequency domain resources assigned on the scheduled cell for the scheduled transmission. This may not be applicable when a single DCI format schedules a plurality of transmissions (e.g., a plurality of PDSCHs or PUSCHs) on a plurality of cells. For example, since different cells may have different bandwidths, the single frequency domain resource assignment (FDRA) in the single DCI format may not be applicable to the plurality of scheduled cells, as this would cause much scheduling restriction. In some embodiments of present disclosure, a separate FDRA field for each of the scheduled cells in a DCI format may be employed. However, this would lead to huge signaling overhead in the scheduling DCI. Embodiments of the present application propose improved solutions for indicating the frequency domain resources for the scheduled cells, which can reduce overhead.

On the other hand, before detecting a DCI format, a UE needs to know the exact payload size of the DCI format. Since the number of cells scheduled by a DCI format may be dynamically changed, this would impact the DCI payload size. As a result, how to determine the payload size of the DCI format should also be resolved.

More details on the embodiments of the present disclosure will be illustrated in the following text in combination with the appended drawings. It should be noted that the solutions of the present disclosure can be applied to both downlink transmissions (e.g., PDSCHs) and uplink transmissions (e.g., PUSCHs) scheduled by a DCI format.

In some embodiments of the present disclosure, a BS may configure a set of cells (denoted as cell set #1) which can be used for multi-cell scheduling for a UE. For example, the BS may transmit a DCI to the UE, and the DCI may schedule one or more downlink transmissions (e.g., PDSCHs) or uplink transmissions (e.g., PUSCHs) on one or more cells of cell set #1.

In some embodiments of the present disclosure, in the case that a single DCI format can schedule multiple cells for downlink or uplink transmission, the scheduled or assigned frequency domain resources (e.g., RBs) on the scheduled cells can be indicated by two fields (denoted as field #A1 and field #A2).

For example, a DCI format may schedule a set of cells (denoted as cell set #2) among cell set #1. Field #A1 of the DCI format may indicate whether one or multiple cells are scheduled by the DCI format. For example, field #A1 indicates cell set #2 among cell set #1. The size of field #A1 may be dependent on the number of cells in cell set #1. For instance, assuming that cell set #1 includes N cells, field #A1 may be an N-bit bitmap with each bit in the bitmap corresponding to one cell of cell set #1. For example, bit value “0” indicates that the corresponding cell is not scheduled while bit value “1” indicates that the corresponding cell is scheduled; or vice versa. In some examples, a UE can be configured up to 4 cells for multi-cell scheduling (e.g., N≤4).

Field #A2 of the DCI format may indicate frequency domain resource assignment with respect to a virtual cell. For example, field #A2 may indicate assigned RBs with respect to the virtual cell. Various methods may be employed to form the virtual cell. For example, the virtual cell may be formed by aggregating all cells of cell set #1 according to a predefined order.

For example, cells in cell set #1 can be aggregated according to a predefined order (e.g., an ascending or descending order) of their cell indexes or carrier frequencies. The RBs of the virtual cell may be contiguously indexed from the lowest RB of the first cell of the aggregated cells (i.e., starting RB of the virtual cell) to the highest RB of the last cell of the aggregated cells (i.e., ending RB of the virtual cell). Alternatively, the RBs of the virtual cell may be contiguously indexed from the highest RB of the last cell of the aggregated cells (i.e., starting RB of the virtual cell) to the lowest RB of the last cell of the aggregated cells (i.e., ending RB of the virtual cell).

For example, assuming that a UE is configured with a set of cells (i.e., cell set #1) including CC 1, CC 2, . . . and CC N for multi-cell scheduling via a single DCI format, CC 1 includes k₁ RBs, CC 2 includes k₂ RBs, CC 3 includes k₃ RBs, . . . , and CC N includes k_{N} RBs, denoting Y=k₁+k₂+k₃+ . . . +k_{N}, then these Y RBs can be contiguously numbered as RB₀, RB₁, . . . , RB_{y-1} from the lowest RB of the first cell of the aggregated cells to the highest RB of the last cell of the aggregated cells.

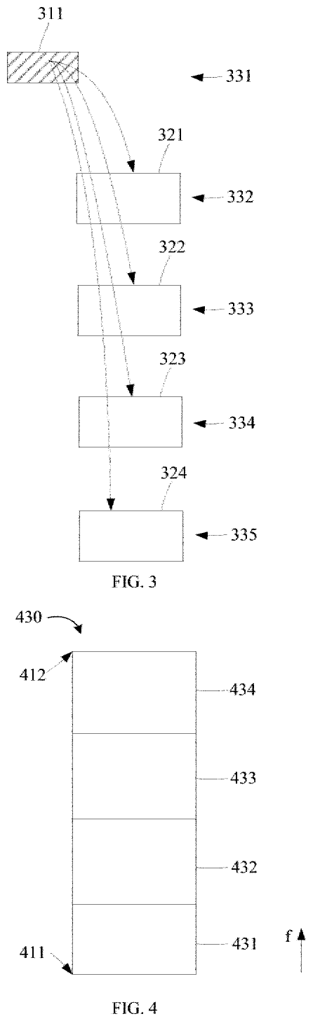

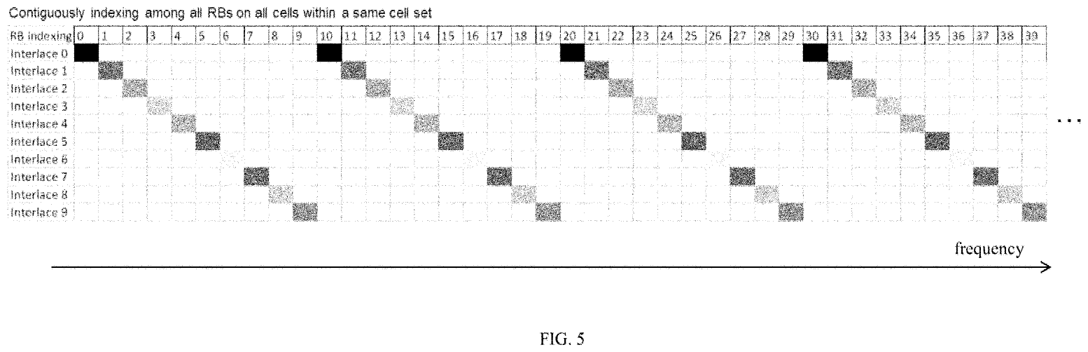

For example, FIG. 4 shows an exemplary virtual cell 430 in accordance with some embodiments of the present disclosure. It is assumed that a UE is configured with CCs 431-434 for multi-cell scheduling and the values of serving cell indexes of CCs 431-434 have the relationship of CC 431<CC 432<CC 433<CC434.

In some examples, CCs 431-434 may be arranged according to an ascending order of their cell indexes and then combined as virtual cell 430 as shown in FIG. 4. RB 411 denotes the lowest RB of the lowest cell (e.g., CC 431) in virtual cell 430 and RB 412 denotes the highest RB of the highest cell (e.g., CC 434) in virtual cell 430.

In some examples, RBs on cell 430 may be contiguously numbered as RB₀, RB₁, . . . , RB_{y-1} from RB 411 (RB₀) to RB 412 (RB_{y-1}), wherein y denotes the total number of RBs on CCs 431-434. That is, RB 411 and RB 412 may be used as the starting RB and ending RB for numbering the RBs of virtual cell 430. In other examples, RB 411 and RB 412 may be used as the ending RB and starting RB for numbering the RBs of virtual cell 430.

In some embodiments, an interlace-based structure can be adopted for the virtual cell. An interlace may be defined as a set of frequency resources (e.g., RBs or RBGs) equally spaced in the frequency domain (e.g., the frequency domain of the virtual cell). For example, an interlace may be defined with reference to the starting RB (e.g., the RB with the smallest index such as RB₀) of the virtual cell.

For example, the virtual cell may include a plurality of interlaces (denoted as interlace set #1). Field #A2 in a DCI format may indicate a set of interlaces (denoted as interlace set #2) from interlace set #1. That is, field #A2 may indicate interlace set #2 on the bandwidth of the virtual cell. The RBs actually scheduled by the DCI format are RBs within the intersection of cell set #2 and interlace set #2.

In some embodiments, an RB-based interlace structure can be adopted. For example, the RB-based interlace structure can be expressed as {RBs p, p+M1, p+2*M1, . . . } within the virtual cell, where p denotes the interlace index and p={0, 1, 2, . . . , M1−1} and M1 denotes the total number of RB-based interlaces within the virtual cell. When the total number of RB-based interlaces on the bandwidth of the virtual cell is determined, the RB-based interlace structure for the virtual cell is determined.

FIG. 5 illustrates an example of RB-based interlace structure in accordance with some embodiments of the present disclosure. It should be understood that the structure in FIG. 5 is only for illustrative purposes, and should not be construed as limiting the embodiments of the present disclosure.

In FIG. 5, the bandwidth of a virtual cell may be partitioned into RBs, which can be indexed according to various methods as mentioned above. For illustrative purposes, FIG. 5 only shows a part of the RBs (e.g., RBs that are indexed from 0 to 39 in FIG. 5) included in the bandwidth of the virtual cell. Persons skilled in the art can readily know the number of RBs included in the bandwidth of a virtual cell based on the carrier bandwidth of cell set #1.

It is assumed that the total number of RB-based interlaces within the virtual cell is 10 (e.g., indexed from interlace 0 to interlace 9 in FIG. 5). Each interlace of the 10 interlaces may include evenly-spaced RBs in the frequency domain. The number of RBs included in each of the 10 interlaces may depend on the bandwidth of the virtual cell. As shown in FIG. 5, interlace 0 may include RB 0, RB 10, RB 20, RB 30, and so on; interlace 1 may include RB 1, RB 11, RB 21, RB 31, and so on; and interlace 9 may include RB 9, RB 19, RB 29, RB 39 and so on.

Various methods may be employed for determining the total number of RB-based interlaces on the bandwidth of a virtual cell.

For example, the total number of RB-based interlaces within a virtual cell may be dependent on the SCS of cell set #1. For example, cells in cell set #1 may have the same SCS. For 15 kHz SCS, the total number of RB-based interlaces within a virtual cell is 10 (e.g., M1=10); and for 30 kHz SCS, the total number of RB-based interlaces within a virtual cell is 5 (e.g., M1=5). In some embodiments, when the SCS configuration is higher than 30 kHz, other methods may be employed for determining the total number of RB-based interlaces within a virtual cell.

For example, the total number of RB-based interlaces within a virtual cell may be configured by a BS. For example, a BS may configure a UE with the total number of RB-based interlaces (e.g., the value of M1) via radio resource control (RRC) signaling, which is applicable to the entire cell set #1.

For example, the total number of RB-based interlaces within a virtual cell may be dependent on a number of RBs between two consecutive RBs of a single interlace on the bandwidth of the virtual cell. For example, a BS may configure a UE with the number of RBs (denoted as M_{RB}) between two consecutive RBs of one RB-based interlace via RRC signaling. The UE can determine the total number of RB-based interlaces within a virtual cell based on the configured information. For example, the value of M1 is equal to the value of M_{RB} or M_{RB}+1.

In some embodiments, an RBG-based interlace structure can be adopted. For example, the RBG-based interlace structure can be expressed as {RBs p*K+j, p*K+j+K*M2, p*K+j+2*K*M2, . . . } within the virtual cell, where p denotes the interlace index and p∈{0, 1, 2, . . . , M2−1}, j denotes the RB index within each RBG and j∈{0, 1, 2, . . . , K−1}, K denotes the RBG size (i.e., the number of contiguous RBs within each RBG), and M2 denotes the total number of RBG-based interlaces within the virtual cell. The RB-based interlace structure can be deemed as a special case of the RBG-based interlace structure where the RBG size is 1.

To determine the RBG-based interlace structure, both the number of RBG-based interlaces and the RBG size are required. In some examples, the two values may be configured via RRC signaling and are applicable to the entire cell set #1.

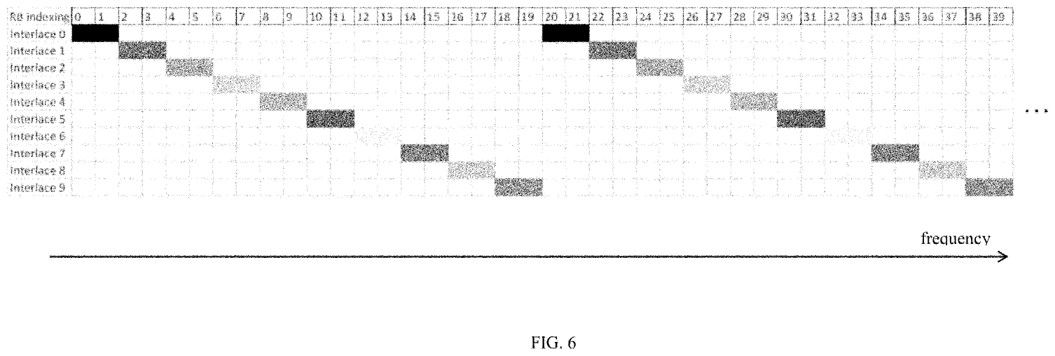

FIG. 6 illustrates an example of RBG-based interlace structure in accordance with some embodiments of the present disclosure. It should be understood that the structure in FIG. 6 is only for illustrative purposes, and should not be construed as limiting the embodiments of the present disclosure.

In FIG. 6, the bandwidth of a virtual cell may be partitioned into RBs, which can be indexed according to various methods as mentioned above. For illustrative purposes, FIG. 6 only shows a part of the RBs (e.g., RBs that are indexed from 0 to 39 in FIG. 6) included in the bandwidth of the virtual cell. Persons skilled in the art can readily know the number of RBs included in the bandwidth of a virtual cell based on the carrier bandwidth of cell set #1.

It is assumed that the total number of RBG-based interlaces within the virtual cell is 10 (e.g., indexed from interlace 0 to interlace 9 in FIG. 6) and the RBG size is 2. Each interlace of the 10 interlaces may include evenly-spaced RBGs in the frequency domain, wherein each RBG includes 2 consecutive RBs. The number of RBs included in each of the 10 interlaces may depend on the bandwidth of the virtual cell. As shown in FIG. 6, interlace 0 may include {RB 0, RB 1}, {RB 20, RB 21}, and so on; interlace 1 may include {RB 2, RB 3}, {RB 22, RB 23} and so on; and interlace 9 may include {RB 18, RB 19}, {RB 38, RB 39}, and so on.

The size of field #A2 may be dependent on the total number of interlaces (denoted as M) on the bandwidth of the virtual cell. For example, the value of M can be implemented as M1 or M2 as discussed above.

For example, field #A2 may be an M-bit bitmap with each bit corresponding to one of the M interlaces on the bandwidth of the virtual cell. For example, field #A2 may be a resource indication value (RIV) which corresponds to a starting interlace index of the scheduled interlaces and the number of the contiguously scheduled interlaces. For example, field #A2 may include ┌log₂(M(M+1)/2)┐ bits.

From a UE's point of view, the RBs scheduled by a DCI format in the frequency domain are the intersection of the cells scheduled by the DCI format indicated by field #A1 and the interlaces scheduled by the DCI format indicated by field #A2. The number of UL transmissions or DL transmissions (e.g., the number of PDSCHs or PUSCHs) scheduled by the DCI format may be equal to the number of scheduled cells.

From a UE's perspective, according to the associated carrier bandwidths of the cells within cell set #1, the UE can determine the total number of RBs of a virtual cell formed by aggregating all cells in cell set #1. The UE can determine the size of field #A1 based on the number of cells in cell set #1 and determine the size of field #A2 based on the interlace structure. Accordingly, the UE can determine the payload size of a DCI format which is capable of scheduling multiple cells. The UE can blindly detect the DCI format based on the payload size. Upon the reception of the DCI format, the UE may firstly determine the scheduled cells based on field #A1 and the scheduled interlaces based on field #A2. Then, the UE can identify the assigned RBs within the intersection of the scheduled cells and the scheduled interlaces.

In some embodiments of the present disclosure, in the case that a single DCI format can schedule multiple cells for downlink or uplink transmission, the scheduled or assigned frequency domain resources (e.g., RBs) on the scheduled cells can be indicated by two fields (denoted as field #B1 and field #B2).

For example, a DCI format may schedule a set of cells (e.g., cell set #2) among cell set #1. Field #B1 of the DCI format may indicate whether one or multiple cells are scheduled by the DCI format. In some embodiments, field #B1 may indicate whether one cell or multiple cells are scheduled by the DCI format. The size of field #B1 may be equal to one bit. For example, bit value “0” indicates only a single cell is scheduled while bit value “1” indicates two or more cells are scheduled; or vice versa. In some embodiments, field #B1 indicates cell set #2 among cell set #1. The size of field #B1 may be dependent on the number of cells in cell set #1. For example, assuming that cell set #1 includes N cells, field #B1 may be an N-bit bitmap with each bit in the bitmap corresponding to one cell of cell set #1. For example, bit value “0” indicates that the corresponding cell is not scheduled while bit value “1” indicates that the corresponding cell is scheduled; or vice versa. In some examples, a UE can be configured up to 4 cells for multi-cell scheduling (e.g., N≤4).

Field #B2 of the DCI format may indicate frequency domain resource assignment. For example, field #B2 may include a plurality of RBG based indicators, each of which may correspond to a cell of cell set #1 and indicate assigned or scheduled RBs (e.g., RBGs) on a corresponding cell.

The plurality of RBG-based indicators in field #B2 may be arranged according to a predefined order. For example, the plurality of RBG-based indicators in field #B2 is ordered in an ascending (or descending) order of serving cell indexes or carrier frequencies of the cells within cell set #1. The size (e.g., the number of bits) of each of the plurality of RBG-based indicators is independently determined based on a resource allocation type for the corresponding cell, an RBG granularity for the corresponding cell, and one of the following: associated carrier bandwidth of the corresponding cell, the largest bandwidth among bandwidth parts (BWPs) of the corresponding cell, and the bandwidth of the current active BWP of the corresponding cell. The payload size of the DCI format can be determined based on the total number of bits required for field #B2.

For example, assuming that cell set #1 includes CC 1, CC 2, . . . and CC N, further assuming the RBG-based allocation indicator for CC 1 requires C1 bits, the RBG-based allocation indicator for CC 2 requires C2 bits, the RBG-based allocation indicator for CC 3 requires C3 bits, . . . , and the RBG-based allocation indicator for CC N requires C_{N} bits, denoting C=C₁+C₂+C₃+ . . . +C_{N}, these C_{N} RBG-based indicators are placed in a predefined order in field #B2 as mentioned above, and the size of field #B2 can be equal to C bits.

For example, for CC i (i∈{1, 2, . . . , N}), Cᵢ can be expressed as: Ci=┌Zᵢ/Pᵢ┐ when resource allocation type 0 is employed for CC i; or

$$Ci = ⌈ {log}_{2} ( ⌈ \frac{{Z}_{i}}{{P}_{i}} ⌉ ( ⌈ \frac{{Z}_{i}}{{P}_{i}} ⌉ + 1 ) / 2 ) ⌉$$

when resource allocation type 1 is employed for CC i, where Zᵢ denotes the number of RBs of CC i and Pᵢ denotes the RBG granularity for CC i, which may be based on the RBG configuration and an associated bandwidth of CC i.

In some embodiments of the present disclosure, the RBG granularity for FDRA indication for multi-cell scheduling is dynamically interpreted according to the number of cells actually scheduled by a DCI format. For example, depending on the number of cells scheduled by the DCI format (e.g., the number of cells in cell set #2 which can be indicated by field #B1 of the DCI format), the RBG granularity associated with an RBG-based indicator in field #B2 of the DCI format may be dynamically interpreted, for example may be the same as or different from the RBG granularity for the corresponding cell.

For example, in the case that the number of cells in cell set #2 is greater than a threshold, the RBG granularity associated with an RBG-based indicator corresponding to each cell of cell set #2 is an RBG granularity for a corresponding cell of cell set #2. For example, in the case that the number of cells in cell set #2 is smaller than or equal to the threshold, the RBG granularity associated with an RBG-based indicator corresponding to each cell of cell set #2 is smaller than or equal to an RBG granularity for a corresponding cell of cell set #2. The threshold can be predefined, for example, in a standard, or configured by a BS, for example, via RRC.

For example, it is assumed that the threshold is equal to 1. When field #B1 indicates that a plurality of cells among cell set #1 is scheduled by the DCI format, field #B2 may include C bits and each RBG-based indicator in field #B2 may correspond to one cell of cell set #1. The RBG granularity associated with an RBG-based indicator corresponding to each cell of cell set #2 is the RBG granularity for a corresponding cell of cell set #2.

For example, assuming that for cell A in cell set #2, resource allocation type 0 is employed, the RBG granularity for cell A can be determined based on the following Table 1. It should be understood that Table 1 is only for illustrative purposes, and should not be construed as limiting the embodiments of the present disclosure.

TABLE 1
RBG size of P

| R | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In Table 1, “R” refers to the number of RBs according to one of the following: associated carrier bandwidth of a cell (e.g., cell A), the largest bandwidth among BWPs of the cell (e.g., cell A), or the bandwidth of the current active BWP of the cell (e.g., cell A). “Configuration 1” and “Configuration 2” refer to different RBG configurations. For example, it is assumed that for cell A, R=35 and configuration 2 is adopted, then according to Table 1, the value of the RBG granularity for cell A is 4. The value of the RBG granularity associated with an RBG-based indicator corresponding to cell A may be 4.

For example, assuming that for cell A in cell set #2, resource allocation type 1 is employed, the RBG granularity for cell A may be equal to a predefined value, for example, 1. Alternatively, the RBG granularity value for cell A may be configured by a BS and may be one of the following: 1, 2, 4, 8, 10, 12, 16, 20, 24, 28, or 32. Other RBG granularity values can also be employed.

The definitions of resource allocation type 0 and resource allocation type 1 can be found in 3GPP standard documents.

When field #B1 indicates that only a single cell in cell set #1 is scheduled by the DCI format (i.e., the number of actually scheduled cells is equal to 1), field #B2 may include C bits and the first X bit of field #B2 may indicate a finer RBG-based allocation, wherein X is the number of required bits for the allowed minimum RBG granularity for the corresponding cell satisfying the condition of X<=C (as mentioned above, C denotes the size of field #B2). Various methods may be employed to determine the value of X based on the above principle.

For example, it is assumed that the DCI format schedules a single cell, denoted as cell B, and resource allocation type 0 is employed for cell B.

In some embodiments, X can be expressed as X=┌Z_{B}/Pₘᵢₙ┐≤C, where Z_{B} denotes the number of RBs of cell B and Pₘᵢₙ denotes the minimum allowed RBG granularity for cell B satisfying ┌Z_{B}/Pₘᵢₙ┐≤C. For example, the allowed or possible RBG granularity values for a cell can include, but are not limited to, 1, 2, 4, 8, 10, 12, 16, 20, 24, 28, and 32. In these embodiments, the RBG granularity associated with the RBG-based indicator corresponding to cell B refers to Pₘᵢₙ.

In some embodiments, X can be expressed as X=┌Z_{B}/P_{B}┐≤C, where Z_{B} denotes the number of RBs of cell B and P_{B} denotes the corresponding RBG granularity for cell B according to RBG configuration and an associated bandwidth (e.g., associated carrier bandwidth of cell B, the largest bandwidth among BWPs of cell B, or the bandwidth of the current active BWP of cell B) and can be determined based on the above Table 1. In these embodiments, the RBG granularity associated with the RBG-based indicator corresponding to cell B refers to P_{B}.

For example, it is assumed that the DCI format schedules a single cell, denoted as cell B, and resource allocation type 1 is employed for cell B.

In some embodiments, X can be expressed as X=┌log₂(N_{RBG,max}(N_{RBG,max}+1)/2)┐≤C, and N_{RBG,max} denotes the maximum number of RBGs on cell B when Pₘᵢₙ is adopted, for example, N_{RBG,max}=┌Z_{B}/Pₘᵢₙ┐, where Z_{B} denotes the number of RBs of cell B and Pₘᵢₙ denotes the minimum allowed RBG granularity for cell B satisfying X≤C. For example, the allowed or possible RBG granularity values can include, but are not limited to, 1, 2, 4, 6, 8, 12, 16, 20, and 32. In these embodiments, the RBG granularity associated with the RBG-based indicator corresponding to cell B refers to Pₘᵢₙ.

In some embodiments, the number of RBs of a certain cell (e.g., Z_{B} for cell B) can be determined based on one of the following: associated carrier bandwidth of the cell (e.g., cell B), the largest bandwidth among BWPs of the cell (e.g., cell B), or the bandwidth of the current active BWP of the cell (e.g., cell B).

At the UE side, the UE can determine the payload size of a DCI format based on, for example, the size of field #B2 (e.g., C bits). For example, the UE can determine the payload size of the DCI format according to the resource allocation type, the associated bandwidth, and the RBG granularity for each cell of cell set #1. The UE can blindly detect a DCI format based on the predetermined payload size. In response to the reception of the DCI format, the UE may check field #B1, identify the scheduled cells and the actual RBG granularity, and then determine the assigned RBs on each of the scheduled cells.

In some examples, the number of UL transmissions or DL transmissions (e.g., the number of PDSCHs or PUSCHs) scheduled by the DCI format may be equal to the number of scheduled cells.

In some embodiments of the present disclosure, in the case that a single DCI format can schedule multiple cells for downlink or uplink transmission, the RBG granularity for each cell of cell set #1 may be independently configured by a BS via, for example, RRC signaling. For example, the RBG granularity for one cell of cell set #1 may be the same as or different from the RBG granularity for another cell of cell set #1.

The resource allocation type (e.g., resource allocation type 0 or resource allocation type 1) for each cell of cell set #1 can be independently configured by a BS via, for example, RRC signaling.

The RBG granularities for different resource allocation types (e.g., resource allocation type 0 or resource allocation type 1) for each cell of cell set #1 may be independently configured by a BS via, for example, RRC signaling. For example, for each cell of cell set #1, when resource allocation type 0 is configured for a corresponding cell, an RBG granularity for resource allocation type 0 (denoted as RBG granularity #1) may be configured for the corresponding cell. For each cell in cell set #1, when resource allocation type 1 is configured for a corresponding cell, an RBG granularity for resource allocation type 1 (denoted as RBG granularity #2) may be configured for the corresponding cell. RBG granularity #1 and RBG granularity #2 can be independently configured. For example, RBG granularity #1 and RBG granularity #2 for a certain cell may be the same or different.

In some embodiments, the allowed or possible RBG granularity values can include, but are not limited to, 1, 2, 4, 8, 10, 12, 16, 20, 24, 28, and 32. For example, the BS may configure the RBG granularity for a cell according to an associated bandwidth of the cell, for example, according to one of the following: associated carrier bandwidth of the cell, the largest bandwidth among BWPs of the cell, or a bandwidth of the current active BWP of the cell. For example, the larger the associated bandwidth of the cell, the greater the configured RBG granularity.

The DCI format may include a plurality of FDRA fields, each of which corresponds to a cell of cell set #1 and indicates assigned RBs on a corresponding cell. For example, assuming that cell set #1 includes N cells, the DCI format includes N FDRA fields. The size of each FDRA field is determined independently. For a certain cell, when the active BWP is changed, the FDRA field size for the cell may not be changed.

The size of each FDRA field may be dependent on a resource allocation type for a corresponding cell, an RBG granularity for the corresponding cell, and one of the following: associated carrier bandwidth of the corresponding cell, the largest bandwidth among BWPs of the corresponding cell, or a bandwidth of the current active BWP of the corresponding cell.

The plurality of FDRA fields in the DCI format can independently indicate the scheduled cells from cell set #1. For example, in the case that a corresponding FDRA field for a certain cell indicates an inapplicable value, this implies that this cell is not scheduled by the DCI format. In the case that the corresponding FDRA field indicates an applicable value, this implies that the cell is scheduled by the DCI format. The number of UL transmissions or DL transmissions (e.g., the number of PDSCHs or PUSCHs) scheduled by the DCI format may be equal to the number of scheduled cells. With this dynamic indication based on the FDRA fields, a BS can dynamically schedule any cell or cell combination within cell set #1. In this way, a DCI format does not need to include an indicator to specifically indicate the scheduled cells. That is, the scheduled cells (e.g., cell set #2) among cell set #1 can be determined based on the plurality of FDRA fields.

In some examples, when resource allocation type 0 is applied to a cell, a corresponding FDRA field for this cell being set to all “0”'s may imply that the cell is not scheduled. Otherwise, this may imply that the cell is scheduled, and the FDRA field may be an RBG-based bitmap indicating the assigned RBs on the scheduled cell. As stated above, the RBG granularity (e.g., RBG granularity #1) for the cell can be configured by the BS.

In some examples, when resource allocation type 1 is applied to a cell, a corresponding FDRA field for this cell being set to all “1”s may imply that the cell is not scheduled. Otherwise, this may imply that the cell is scheduled, and the FDRA field may be an RBG-based RIV indicating the assigned RBs on the scheduled cell. As stated above, the RBG granularity (e.g., RBG granularity #2) for the cell can be configured by the BS.

By introducing the RBG-based FDRA indication (e.g., RBG-based bitmap or RBG-based RIV in the FDRA field), the total size of the FDRA fields in a DCI format can be reduced. For example, as stated above, the allowed or possible RBG granularity values can include, but are not limited to, 1, 2, 4, 8, 10, 12, 16, 20, 24, 28, and 32. The larger the RBG granularity, the smaller the number of required bits for a corresponding FDRA field in the DCI format. The number of required bits for a FDRA field (e.g., the size of the FDRA field) in a multi-cell scheduling DCI format thus can be controlled to an appropriate value.

For example, for a cell C in cell set #1, when resource allocation type 0 is employed, the size of the FDRA field corresponding to cell C in a DCI format may be based on (e.g., equal to) the number of RBGs on cell C, which can be given by N_{RBG,c}=┌Y_{c}/P_{c}┐, where N_{RBG,c} denotes the number of RBGs on cell C, Yc denotes the number of RBs of cell C, and Pc denotes the RBG granularity for cell C.

When resource allocation type 1 is employed for cell C, the size of the FDRA field corresponding to cell C in a DCI format may be based on (e.g., equal to) ┌log₂(N_{RBG,c}(N_{RBG,c}+1)/2)┐, where N_{RBG,c} denotes the number of RBGs on cell C and N_{RBG,c}=┌Y_{c}/P_{c}┐, where Yc denotes the number of RBs of cell C and Pc denotes the RBG granularity for cell C.

In some embodiments, the number of RBs of a certain cell (e.g., Yc for cell C) can be determined based on one of the following: associated carrier bandwidth of the cell (e.g., cell C), the largest bandwidth among BWPs of the cell (e.g., cell C), or the bandwidth of the current active BWP of the cell (e.g., cell C).

At the UE side, the UE can determine the payload size of a DCI format based on, for example, the sizes of the plurality of FDRA fields. For example, the UE can determine the payload size of the DCI format according to the resource allocation type, the associated bandwidth, and the RBG granularity for each cell of cell set #1. The UE can blindly detect a DCI format based on the predetermined payload size. In response to the reception of the DCI format, the UE may check the FDRA fields, identify the scheduled cells and determine the assigned RBs on each of the scheduled cells.

In some embodiments of the present disclosure, in the case that a single DCI format can schedule multiple cells for downlink or uplink transmission, all cells of cell set #1 may have the same resource allocation type. For example, resource allocation type 0 is configured or predefined for all cells within cell set #1. All cells of cell set #1 may have the same RBG granularity, which may be configured by a BS, for example, via RRC signaling or predefined, for example, in a standard. In some embodiments, the RBG granularity for cell set #1 can be configured or predefined according to the total bandwidth of cell set #1. The allowed possible RBG granularity values can include, but are not limited to, 1, 2, 4, 8, 10, 12, 16, 20, 24, 28, 32, 40, 50, and 64.

All cells in cell set #1 may be aggregated to form a virtual cell. The methods for forming the virtual cell and the methods for indexing the RBs on the virtual cell as described in the forgoing embodiments can be applied here.

For example, the virtual cell can be formed by aggregating all cells of cell set #1 according to a predefined order. For example, cells in cell set #1 can be aggregated according to a predefined order (e.g., an ascending or descending order) of their cell indexes or carrier frequencies. The RBs of the virtual cell can be contiguously indexed from the lowest RB of the first cell of the aggregated cells to the highest RB of the last cell of the aggregated cells.

For example, assuming that a UE is configured with a set of cells (i.e., cell set #1) including CC 1, CC 2, . . . and CC N for multi-cell scheduling via a single DCI format, CC 1 includes k₁ RBs, CC 2 includes k₂ RBs, CC 3 includes k₃ RBs, . . . , and CC N includes k_{N} RBs, denoting Y=k₁+k₂+k₃+ . . . +k_{N}, then these Y RBs are contiguously numbered as RB₀, RB₁, . . . , RB_{y-1} from the lowest RB of the first cell of the aggregated cells to the highest RB of the last cell of the aggregated cells. An exemplary virtual cell is shown in FIG. 4.

A DCI format may include a single FDRA field (denoted as field #D), which indicates assigned or scheduled RBGs on the virtual cell. For example, field #D may be an RBG-based bitmap or RBG-based RIV. For instance, field #D may be an RBG-based bitmap indicating the assigned or scheduled RBGs on the virtual cell which can be mapped to at least one complete RBG or at least one partial RBG on at least one cell of cell set #1. When at least one RB of an assigned or scheduled RBG is located on a cell of cell set #1, then it implies the cell is scheduled by the DCI format. When none RB of the assigned or scheduled RBGs is located on a cell of cell set #1, then it implies the cell is not scheduled by the DCI format. The size of field #D may be dependent on a total bandwidth of cell set #1 and an RBG granularity for cell set #1. As stated above, cells in cell set #1 may have the same RBG granularity.

Field #D can jointly indicate the cells scheduled by the DCI format and the scheduled RBs on the scheduled cells. For example, in the case that field #D indicates no complete or partial RBG on a certain cell of cell set #1, this implies that this cell is not scheduled by the DCI format. In the case that field #D indicates at least one complete RBG or at least one partial RBG on the cell, this implies that this cell is scheduled by the DCI format. When at least one RB of an assigned or scheduled RBG is located on a cell of cell set #1, then it implies the cell is scheduled by the DCI format. When none RB of the assigned or scheduled RBGs is located on a cell of cell set #1, then it implies the cell is not scheduled by the DCI format. The number of UL transmissions or DL transmissions (e.g., the number of PDSCHs or PUSCHs) scheduled by the DCI format may be equal to the number of scheduled cells. With this dynamic indication based on the FDRA field, a BS can dynamically schedule any cell or cell combination within cell set #1. In this way, a DCI format does not need to include an indicator to specifically indicate the scheduled cells.

By introducing the RBG-based FDRA indication (e.g., RBG-based bitmap or RBG-based RIV in the FDRA field), the total size of the FDRA field in a DCI format can be reduced.

For example, as stated above, the allowed or possible RBG granularity values can include, but are not limited to, 1, 2, 4, 8, 10, 12, 16, 20, 24, 28, 32, 40, 50, and 64. The larger the RBG granularity, the smaller the number of required bits for field #D in the DCI format. The number of required bits for a FDRA field (e.g., the size of field #D) in a multi-cell scheduling DCI format thus can be controlled to an appropriate value.

For example, the size of field #D in a DCI format may be based on (e.g., equal to) the number of total RBGs on the virtual cell, which can be given by N_{RBG}=┌Y/P┐, where N_{RBG} denotes the number of RBGs for the virtual cell, Y denotes the total number of RBs of the virtual cell and P denotes the RBG granularity configured for cell set #1.

At the UE side, the UE can determine the payload size of a DCI format based on, for example, the size of field #D. For example, the UE can determine the payload size of the DCI format according to the resource allocation type, the bandwidth of cell set #1 and the RBG granularity for cell set #1. The UE can blindly detect a DCI format based on the predetermined payload size. In response to the reception of the DCI format, the UE may check field #D, identify the scheduled cells and determine the assigned RBs on each of the scheduled cells.

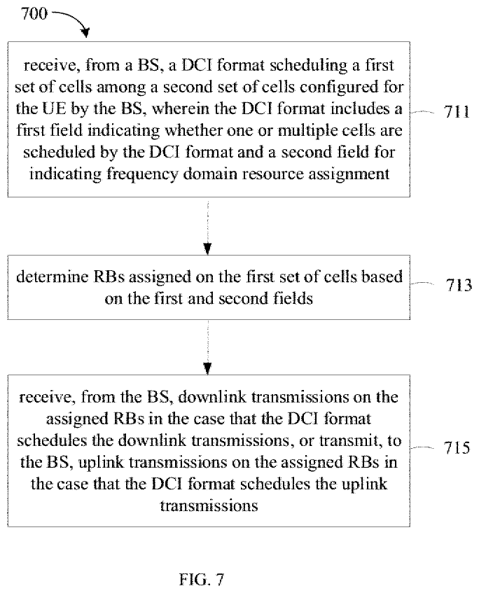

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a UE, for example, UE 101 in FIG. 1.

Referring to FIG. 7, in operation 711, the UE may receive, from a BS, a DCI format scheduling a first set of cells (e.g., cell set #2) among a second set of cells (e.g., cell set #1) configured for the UE by the BS, wherein the DCI format includes a first field indicating whether one or multiple cells are scheduled by the DCI format and a second field for indicating frequency domain resource assignment.

In some embodiments of the present disclosure, the first field and the second field may respectively be field #A1 and field #A2 as described above. In some embodiments of the present disclosure, the first field and the second field may respectively be field #B1 and field #B2 as described above.

In operation 713, the UE may determine RBs assigned on the first set of cells based on the first and second fields. In operation 715, the UE may receive, from the BS, downlink transmissions (e.g., PDSCHs) on the assigned RBs in the case that the DCI format schedules the downlink transmissions, or transmit, to the BS, uplink transmissions (e.g., PUSCHs) on the assigned RBs in the case that the DCI format schedules the uplink transmissions.

In some embodiments of the present disclosure, a size of the first field is equal to one bit. In some embodiments of the present disclosure, the first field indicates the first set of cells, and the size of the first field is dependent on a number of cells in the second set of cells.

In some embodiments of the present disclosure, a number of the downlink transmissions or uplink transmissions is equal to a number of cells in the first set of cells.

In some embodiments of the present disclosure, the second field indicates a set of interlaces on a bandwidth of a virtual cell formed by aggregating all cells of the second set of cells according to a predefined order.

In some embodiments of present disclosure, the assigned RBs are RBs within the intersection of the first set of cells and the set of interlaces.

In some embodiments of present disclosure, the interlace is an RB-based interlace, and a total number of RB-based interlaces on the bandwidth of the virtual cell is: dependent on the SCS of the second set of cells; configured by the BS; or dependent on a number of RBs between two consecutive RBs of a single interlace on the bandwidth of the virtual cell.

In some embodiments of present disclosure, the interlace is an RBG based interlace, and a total number of RBG-based interlaces on the bandwidth of the virtual cell and an RBG size associated with the RBG-based interlace are configured by the BS.

In some embodiments of present disclosure, a size of the second field is dependent on a total number of interlaces on the bandwidth of the virtual cell.

In some embodiments of the present disclosure, the second field includes a plurality of RBG based indicators, each of which corresponds to a cell of the second set of cells and indicates assigned RBGs on a corresponding cell.

In some embodiments of present disclosure, a size of each RBG-based indicator of the plurality of RBG-based indicators is dependent on a resource allocation type for a corresponding cell, an RBG granularity for the corresponding cell, and one of the following: associated carrier bandwidth of the corresponding cell, the largest bandwidth among BWPs of the corresponding cell, and a bandwidth of the current active BWP of the corresponding cell.

In some embodiments of present disclosure, the UE may determine an RBG granularity associated with an RBG-based indicator corresponding to each cell of the first set of cells according to a number of cells in the first set of cells.

In some embodiments of present disclosure, in the case that the number of cells in the first set of cells is greater than a threshold, the RBG granularity associated with an RBG-based indicator corresponding to each cell of the first set of cells is an RBG granularity for a corresponding cell of the first set of cells. In some embodiments of the present disclosure, in the case that the number of cells in the first set of cells is smaller than or equal to the threshold, the RBG granularity associated with an RBG-based indicator corresponding to each cell of the first set of cells is smaller than or equal to an RBG granularity for a corresponding cell of the first set of cells.

In some embodiments of present disclosure, the plurality of RBG-based indicators in the second field is arranged according to a predefined order.

It should be appreciated by persons skilled in the art that the sequence of the operations in exemplary procedure 700 may be changed and some of the operations in exemplary procedure 700 may be eliminated or modified, without departing from the spirit and scope of the disclosure.

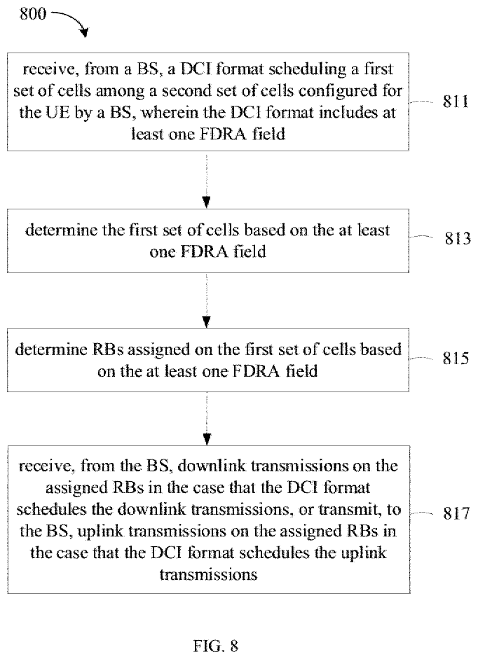

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. In some examples, the procedure may be performed by a UE, for example, UE 101 in FIG. 1.

Referring to FIG. 8, in operation 811, the UE may receive, from a BS, a DCI format scheduling a first set of cells (e.g., cell set #2) among a second set of cells (e.g., cell set #1) configured for the UE by a BS, wherein the DCI format includes at least one FDRA field.

In some embodiments of the present disclosure, the at least one FDRA field may be the plurality of FDRA fields as described above. In some embodiments of the present disclosure, the at least one FDRA field may be field #D as described above.

In operation 813, the UE may determine the first set of cells based on the at least one FDRA field. In operation 815, the UE may determine RBs assigned on the first set of cells based on the at least one FDRA field.

In operation 817, the UE may receive, from the BS, downlink transmissions (e.g., PDSCHs) on the assigned RBs in the case that the DCI format schedules the downlink transmissions, or transmit, to the BS, uplink transmissions (e.g., PUSCHs) on the assigned RBs in the case that the DCI format schedules the uplink transmissions.

In some embodiments of the present disclosure, a number of the downlink transmissions or uplink transmissions is equal to a number of cells in the first set of cells.

In some embodiments of the present disclosure, each of the at least one FDRA field corresponds to a cell of the second set of cells and indicates assigned RBs on a corresponding cell.

In some embodiments of present disclosure, a size of each FDRA field of the at least one FDRA field is dependent on a resource allocation type for a corresponding cell, an RBG granularity for the corresponding cell, and one of the following: associated carrier bandwidth of the corresponding cell, the largest bandwidth among BWPs of the corresponding cell, or a bandwidth of the current active BWP of the corresponding cell.

In some embodiments of present disclosure, determining the first set of cells based on the at least one FDRA field includes for each cell of the second set of cells: in the case that a corresponding FDRA field of the at least one FDRA field indicates an inapplicable value, determining that a corresponding cell is not scheduled by the DCI format; or in the case that the corresponding FDRA field of the at least one FDRA field indicates an applicable value, determining that the corresponding cell is scheduled by the DCI format.

In some embodiments of the present disclosure, an RBG granularity for each cell of the second set of cells are independently configured by the BS. In some embodiments of the present disclosure, a resource allocation type for each cell of the second set of cells are independently configured by the BS. In some embodiments of the present disclosure, RBG granularities for different resource allocation types for each cell of the second set of cells are independently configured by the BS.

In some embodiments of the present disclosure, the configured RBG granularity for a cell of the second set of cells is dependent on one of the following: associated carrier bandwidth of the cell, the largest bandwidth among the BWPs of the cell, or a bandwidth of the current active BWP of the cell.

In some embodiments of the present disclosure, all cells of the second set of cells have the same resource allocation type. In some embodiments of the present disclosure, all cells of the second set of cells have the same RBG granularity, which is dependent on a total bandwidth of the second set of cells.

In some embodiments of the present disclosure, the at least one FDRA field includes a single FDRA field, which indicates assigned RBGs on a virtual cell formed by aggregating all cells of the second set of cells according to a predefined order.

In some embodiments of the present disclosure, a size of the single FDRA field is dependent on a total bandwidth of the second set of cells and an RBG granularity for the second set of cells.

In some embodiments of the present disclosure, determining the first set of cells based on the at least one FDRA field includes for each cell of the second set of cells: in the case that the single FDRA field indicates no complete or partial RBG on a corresponding cell, determining that the corresponding cell is not scheduled by the DCI format; or in the case that the single FDRA field indicates at least one complete RBG or at least one partial RBG on the corresponding cell, determining that the corresponding cell is scheduled by the DCI format.

It should be appreciated by persons skilled in the art that the sequence of the operations in exemplary procedure 800 may be changed and some of the operations in exemplary procedure 800 may be eliminated or modified, without departing from the spirit and scope of the disclosure.

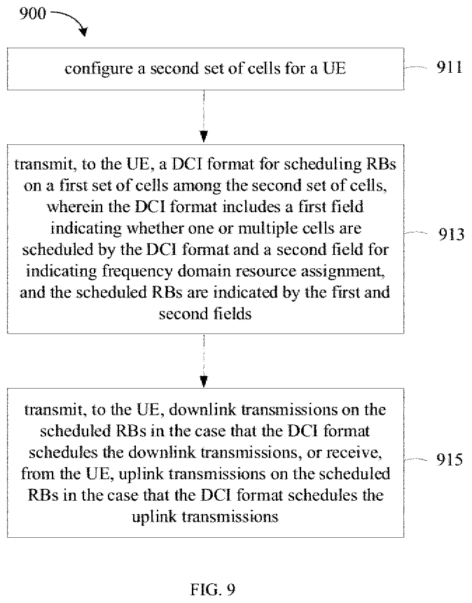

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. In some examples, the procedure may be performed by a BS, for example, BS 102 in FIG. 1.

Referring to FIG. 9, in operation 911, a BS may configure a second set of cells (e.g., cell set #1) for a UE. In operation 913, the BS may transmit, to the UE, a DCI format for scheduling RBs on a first set of cells (e.g., cell set #2) among the second set of cells, wherein the DCI format includes a first field indicating whether one or multiple cells are scheduled by the DCI format and a second field for indicating frequency domain resource assignment, and the scheduled RBs are indicated by the first and second fields.

In some embodiments of the present disclosure, the first field and the second field may respectively be field #A1 and field #A2 as described above. In some embodiments of the present disclosure, the first field and the second field may respectively be field #B1 and field #B2 as described above.

In operation 915, the BS may transmit, to the UE, downlink transmissions (e.g., PDSCHs) on the scheduled RBs in the case that the DCI format schedules the downlink transmissions, or receive, from the UE, uplink transmissions (e.g., PUSCHs) on the scheduled RBs in the case that the DCI format schedules the uplink transmissions.

In some embodiments of the present disclosure, a size of the first field is equal to one bit. In some embodiments of the present disclosure, the first field indicates the first set of cells, and the size of the first field is dependent on a number of cells in the second set of cells.

In some embodiments of the present disclosure, a number of the downlink transmissions or uplink transmissions is equal to a number of cells in the first set of cells.

In some embodiments of the present disclosure, the second field indicates a set of interlaces on a bandwidth of a virtual cell formed by aggregating all cells of the second set of cells according to a predefined order.

In some embodiments of the present disclosure, the scheduled RBs are RBs within the intersection of the first set of cells and the set of interlaces.

In some embodiments of the present disclosure, the interlace is an RB-based interlace, and a total number of RB-based interlaces on the bandwidth of the virtual cell is: dependent on the SCS of the second set of cells; configured by the BS; or dependent on a number of RBs between two consecutive RBs of a single interlace on the bandwidth of the virtual cell.

In some embodiments of the present disclosure, the interlace is an RBG based interlace, and a total number of RBG-based interlaces on the bandwidth of the virtual cell and an RBG size associated with the RBG-based interlace are configured by the BS.

In some embodiments of the present disclosure, a size of the second field is dependent on a total number of interlaces on the bandwidth of the virtual cell.

In some embodiments of the present disclosure, the second field includes a plurality of RBG based indicators, each of which corresponds to a cell of the second set of cells and indicates scheduled RBGs on a corresponding cell.

In some embodiments of the present disclosure, a size of each RBG-based indicator of the plurality of RBG-based indicators is dependent on a resource allocation type for a corresponding cell, an RBG granularity for the corresponding cell, and one of the following: associated carrier bandwidth of the corresponding cell, the largest bandwidth among BWPs of the corresponding cell, and a bandwidth of the current active BWP of the corresponding cell.

In some embodiments of the present disclosure, the BS may determine an RBG granularity associated with an RBG-based indicator corresponding to each cell of the first set of cells according to a number of cells in the first set of cells.

In some embodiments of the present disclosure, in the case that the number of cells in the first set of cells is greater than a threshold, the RBG granularity associated with an RBG-based indicator corresponding to each cell of the first set of cells is an RBG granularity for a corresponding cell of the first set of cells. In some embodiments of the present disclosure, in the case that the number of cells in the first set of cells is smaller than or equal to the threshold, the RBG granularity associated with an RBG-based indicator corresponding to each cell of the first set of cells is smaller than or equal to an RBG granularity for a corresponding cell of the first set of cells.

In some embodiments of the present disclosure, the plurality of RBG-based indicators in the second field is arranged according to a predefined order.

It should be appreciated by persons skilled in the art that the sequence of the operations in exemplary procedure 900 may be changed and some of the operations in exemplary procedure 900 may be eliminated or modified, without departing from the spirit and scope of the disclosure.

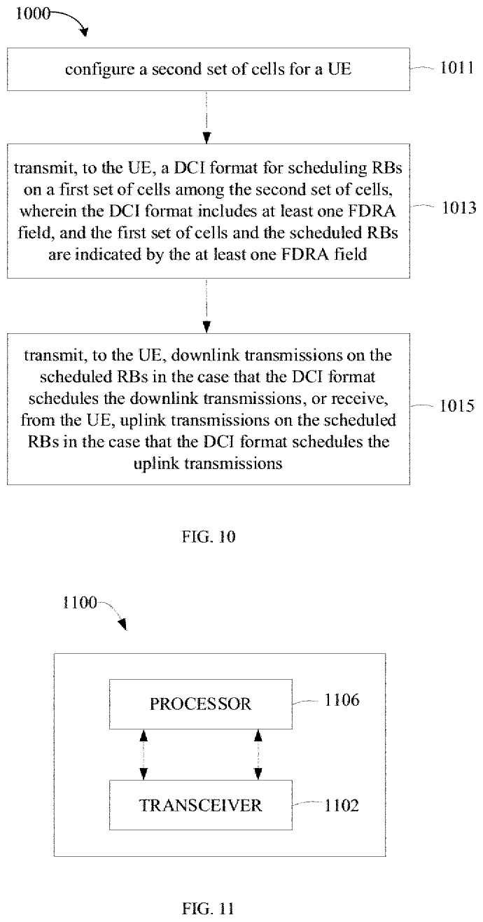

FIG. 10 illustrates a flow chart of exemplary procedure 1000 for wireless communications in accordance with some embodiments of the present disclosure. Details described in all of the foregoing embodiments of the present disclosure are applicable for the embodiments shown in FIG. 10. In some examples, the procedure may be performed by a BS, for example, BS 102 in FIG. 1.

Referring to FIG. 10, in operation 1011, a BS may configure a second set of cells (e.g., cell set #1) for a UE. In operation 1013, the BS may transmit, to the UE, a DCI format for scheduling RBs on a first set of cells (e.g., cell set #2) among the second set of cells, wherein the DCI format includes at least one FDRA field, and the first set of cells and the scheduled RBs are indicated by the at least one FDRA field.

In some embodiments of the present disclosure, the at least one FDRA field may be the plurality of FDRA fields as described above. In some embodiments of the present disclosure, the at least one FDRA field may be field #D as described above.

In operation 1015, the BS may transmit, to the UE, downlink transmissions (e.g., PDSCHs) on the scheduled RBs in the case that the DCI format schedules the downlink transmissions, or receive, from the UE, uplink transmissions (e.g., PUSCHs) on the scheduled RBs in the case that the DCI format schedules the uplink transmissions.

In some embodiments of the present disclosure, a number of the downlink transmissions or uplink transmissions is equal to a number of cells in the first set of cells.

In some embodiments of the present disclosure, each of the at least one FDRA field corresponds to a cell of the second set of cells and indicates scheduled RBs on a corresponding cell.

In some embodiments of the present disclosure, a size of each FDRA field of the at least one FDRA field is dependent on a resource allocation type for a corresponding cell, an RBG granularity for the corresponding cell, and one of the following: associated carrier bandwidth of the corresponding cell, the largest bandwidth among BWPs of the corresponding cell, or a bandwidth of the current active BWP of the corresponding cell.

In some embodiments of the present disclosure, the BS may for each cell of the second set of cells: in the case that a corresponding cell is not scheduled by the DCI format, set a corresponding FDRA field of the at least one FDRA field to indicate an inapplicable value; or in the case that the corresponding cell is scheduled by the DCI format, set the corresponding FDRA field of the at least one FDRA field to indicate an applicable value.

In some embodiments of the present disclosure, the BS may perform at least one of the following: independently configuring an RBG granularity for each cell of the second set of cells; independently configuring a resource allocation type for each cell of the second set of cells; or independently configuring RBG granularities for different resource allocation types for each cell of the second set of cells.

In some embodiments of the present disclosure, the configured RBG granularity for a cell of the second set of cells is dependent on one of the following: associated carrier bandwidth of the cell, the largest bandwidth among BWPs of the cell, or a bandwidth of the current active BWP of the cell.

In some embodiments of the present disclosure, all cell of the second set of cells have the same resource allocation type. In some embodiments of the present disclosure, all cells of the second set of cells have the same RBG granularity, which is dependent on a total bandwidth of the second set of cells.

In some embodiments of the present disclosure, the at least one FDRA field includes a single FDRA field, which indicates scheduled RBGs on a virtual cell formed by aggregating all cells of the second set of cells according to a predefined order.

In some embodiments of the present disclosure, a size of the single FDRA field is dependent on a total bandwidth of the second set of cells and an RBG granularity for the second set of cells.

In some embodiments of the present disclosure, the BS may: for each cell of the second set of cells, in the case that a corresponding cell is not scheduled by the DCI format, set the single FDRA field to indicate no complete or partial RBG on the corresponding cell; or in the case that the corresponding cell is scheduled by the DCI format, set the single FDRA field to indicate at least one complete RBG or at least one partial RBG on the corresponding cell.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a block diagram of exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The transceiver 1102 and the processor 1106 may interact with each other so as to perform the operations with respect to the UE described in FIGS. 1-10. In some embodiments of the present application, the apparatus 1100 may be a BS. The transceiver 1102 and the processor 1106 may interact with each other so as to perform the operations with respect to the BS described in FIGS. 1-10.

In some embodiments of the present application, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive, from a base station, a downlink control information (DCI) format scheduling a first set of cells among a second set of cells configured for the UE by the base station, wherein the DCI format includes a first field indicating whether one or multiple cells are scheduled by the DCI format and a second field for indicating frequency domain resource assignment;
determine resource blocks (RBs) assigned on the first set of cells based on the first and second fields; and
receive, from the base station, downlink transmissions on the assigned RBs in that response to the DCI format scheduling the downlink transmissions, or transmit, to the base station, uplink transmissions on the assigned RBs in response to the DCI format scheduling the uplink transmissions.

2. The UE of claim 1, wherein a size of the first field is equal to one bit; or the first field indicates the first set of cells, and the size of the first field is dependent on a number of cells in the second set of cells; and
wherein the second field indicates a set of interlaces on a bandwidth of a virtual cell formed by aggregating all cells of the second set of cells according to a predefined order.

3. The UE of claim 2, wherein the assigned RBs are RBs within an intersection of the first set of cells and the set of interlaces.

4. The UE of claim 2, wherein the interlace is an RB-based interlace, and a total number of RB-based interlaces on the bandwidth of the virtual cell is:
dependent on subcarrier spacing (SCS) of the second set of cells;
configured by the base station; or
dependent on a number of RBs between two consecutive RBs of a single interlace on the bandwidth of the virtual cell.

5. The UE of claim 2, wherein the interlace is an RB group (RBG) based interlace, and a total number of RBG-based interlaces on the bandwidth of the virtual cell and an RBG size associated with the RBG-based interlace are configured by the base station.

6. The UE of claim 1, wherein the second field comprises a plurality of RB group (RBG) based indicators, each of which corresponds to a cell of the second set of cells and indicates assigned RBGs on a corresponding cell.

7. The UE of claim 6, wherein the at least one processor is configured to cause the UE to determine an RBG granularity associated with an RBG-based indicator corresponding to each cell of the first set of cells according to a number of cells in the first set of cells.

8. The UE of claim 7, wherein, in response to the number of cells in the first set of cells being greater than a threshold, the RBG granularity associated with an RBG-based indicator corresponding to each cell of the first set of cells is an RBG granularity for a corresponding cell of the first set of cells; or
in response to the number of cells in the first set of cells being smaller than or equal to the threshold, the RBG granularity associated with an RBG-based indicator corresponding to each cell of the first set of cells is smaller than or equal to an RBG granularity for a corresponding cell of the first set of cells.

9. A user equipment (UE), comprising:
at least one memory; and
at least one processor coupled with the at least one memory and configured to cause the UE to:
receive, from a base station, a downlink control information (DCI) format scheduling a first set of cells among a second set of cells configured for the UE by the base station, wherein the DCI format includes at least one frequency domain resource assignment (FDRA) field;
determine the first set of cells based on the at least one FDRA field;
determine resource blocks (RBs) assigned on the first set of cells based on the at least one FDRA field; and
receive, from the base station, downlink transmissions on the assigned RBs in response to the DCI format scheduling the downlink transmissions, or transmit, to the base station, uplink transmissions on the assigned RBs in response to the DCI format scheduling the uplink transmissions.

10. The UE of claim 9, wherein each of the at least one FDRA field corresponds to a cell of the second set of cells and indicates assigned RBs on a corresponding cell.

11. The UE of claim 10, wherein determining the first set of cells based on the at least one FDRA field comprises for each cell of the second set of cells:
in response to a corresponding FDRA field of the at least one FDRA field indicating an inapplicable value, determining that a corresponding cell is not scheduled by the DCI format; or
in response to the corresponding FDRA field of the at least one FDRA field indicating an applicable value, determining that the corresponding cell is scheduled by the DCI format.

12. The UE of claim 9, wherein an RBG granularity for each cell of the second set of cells is independently configured by the base station;
wherein a resource allocation type for each cell of the second set of cells is independently configured by the base station; or
wherein RBG granularities for different resource allocation types for each cell of the second set of cells are independently configured by the base station.

13. The UE of claim 9, wherein the at least one FDRA field comprises a single FDRA field, which indicates assigned RB groups (RBGs) on a virtual cell formed by aggregating all cells of the second set of cells according to a predefined order.

14. The UE of claim 13, wherein determining the first set of cells based on the at least one FDRA field comprises for each cell of the second set of cells:
in response to the single FDRA field indicating no complete or partial RBG on a corresponding cell, determining that the corresponding cell is not scheduled by the DCI format; or
in response to the single FDRA field indicating at least one complete RBG or at least one partial RBG on the corresponding cell, determining that the corresponding cell is scheduled by the DCI format.

15. A base station, comprising:
at least one memory; and
at least one processor coupled with the at least one memory and configured to cause the base station to:
configure a second set of cells for a user equipment (UE);
transmit, to the UE, a downlink control information (DCI) format for scheduling resource blocks (RBs) on a first set of cells among the second set of cells, wherein the DCI format includes a first field indicating whether one or multiple cells are scheduled by the DCI format and a second field for indicating frequency domain resource assignment, and the scheduled RBs are indicated by the first and second fields; and
transmit, to the UE, downlink transmissions on the scheduled RBs in response to the DCI format scheduling the downlink transmissions, or receive, from the UE, uplink transmissions on the scheduled RBs in response to the DCI format scheduling the uplink transmissions.

16. A processor for wireless communication, comprising:
at least one controller coupled with at least one memory and configured to cause the processor to:
receive, from a base station, a downlink control information (DCI) format scheduling a first set of cells among a second set of cells configured for the processor by the base station, wherein the DCI format includes a first field indicating whether one or multiple cells are scheduled by the DCI format and a second field for indicating frequency domain resource assignment;
determine resource blocks (RBs) assigned on the first set of cells based on the first and second fields; and
receive, from the base station, downlink transmissions on the assigned RBs in response to the DCI format scheduling the downlink transmissions, or transmit, to the base station, uplink transmissions on the assigned RBs in the response to the DCI format scheduling the uplink transmissions.

17. The processor of claim 16, wherein a size of the first field is equal to one bit; or
the first field indicates the first set of cells, and the size of the first field is dependent on a number of cells in the second set of cells; and
wherein the second field indicates a set of interlaces on a bandwidth of a virtual cell formed by aggregating all cells of the second set of cells according to a predefined order.

18. The processor of claim 17, wherein the assigned RBs are RBs within an intersection of the first set of cells and the set of interlaces.

19. The processor of claim 17, wherein the interlace is an RB-based interlace, and a total number of RB-based interlaces on the bandwidth of the virtual cell is:
dependent on subcarrier spacing (SCS) of the second set of cells;
configured by the base station; or
dependent on a number of RBs between two consecutive RBs of a single interlace on the bandwidth of the virtual cell.

20. The processor of claim 17, wherein the interlace is an RB group (RBG) based interlace, and a total number of RBG-based interlaces on the bandwidth of the virtual cell and an RBG size associated with the RBG-based interlace are configured by the base station.
